(19) United States
(12) Patent Application Publication
(10) Pub. No.: US 2009/0320669 A1
(43) Pub. Date: Dec. 31, 2009

(54) Composition production with audience participation

(76) Inventor: Gregory A. Piccionelli, Westlake Village, CA (US)

Correspondence Address: Michael M. Gerardi, 2801 Townsgate Road, Suite 200, Westlake Village, CA, 91361, US

(21) Appl. No.: 12/381,574

(22) Filed: Mar. 12, 2009

Related U.S. Application Data
(60) Provisional application No. 61/124,224, filed on Apr. 14, 2008.

(51) Int. Cl. G10H 7/00

(52) U.S. Cl. 84/609

(57) ABSTRACT

In a method of producing a composition having a primary component and a secondary component, a primary component is generated by a primary producer. A secondary component is generated by a secondary producer while the primary producer is generating the primary component; the secondary component is selected from a menu provided to the secondary producer. The primary component and the secondary component are then combined to produce the composition.

This application is based on U.S. Provisional Patent Application Ser. No. 61/124,224, filed Apr. 14, 2008, the entire disclosure of which is incorporated herein by reference.

### FIELD OF THE INVENTION

The present invention relates to methods for producing a composition, such as a musical composition or a visual composition such as a painting. More particularly, the present invention relates to methods enabling live performers and audience members jointly to produce musical, artistic or other works, each such work being uniquely created during a particular performance at a particular performance venue.

### BACKGROUND OF THE INVENTION

Presently, audience participation at events such as musical concerts, plays, literary readings and the like, is limited to expressions of approval, such as cheering, shouting out requests for specific songs, clapping, or lighting cigarette lighters. However, the proliferation of cellular telephones, camera phones, and more advanced telecommunication devices such as I-Phones®, has created the possibility for more active collaboration between performers and their audiences, and for the creation of unique works of music, painting, literature and the like resulting from such collaboration.

A need exists for methods of producing compositions, such as songs, paintings, and the like, which afford audience members the opportunity to make contributions to the compositions.

A need also exists for methods of producing such unique compositions which further allows for the production of customized recordings uniquely associated with the live performances upon which they are based.

### SUMMARY OF THE PREFERRED EMBODIMENTS

In accordance with one aspect of the invention, there is provided a method of producing a composition having a primary component and a secondary component. The method includes the steps of: generating a primary component, the primary component being generated by a primary producer; generating a secondary component, the second component being generated by a secondary producer during the first step, the secondary component being selected from a menu provided to the secondary producer; and combining the primary component and the secondary component to produce the composition.

In particular embodiments, the primary producer generates the primary component by performing before an audience that includes the secondary producer.

The secondary producer, in more specific embodiments, is provided with an application that generates the secondary component. The application includes the menu, and the secondary producer selects the secondary component from the menu, which causes the application to generate the secondary component. More specifically, the secondary producer accesses the application using a telecommunication device.

According to particular embodiments, the primary producer combines the primary component and the secondary component. In certain of such embodiments, the secondary producer provides the secondary component to the primary producer using a telecommunication device.

The composition can be recorded or otherwise reproduced according to additional particular embodiments, thus allowing the composition to be made available to the secondary producer or others.

Two or more secondary producers can participate in the production of the composition. Thus, according to additional specific embodiments, a plurality of secondary producers generate a plurality of secondary components, and thus a plurality of compositions are produced, each composition including the primary component and at least one of the plurality of secondary components. When multiple secondary producers participate in the production, in particular embodiments a counter tracks the number of times each secondary component is selected from the menu. A maximum is specified for each secondary component such that a secondary component is removed from the menu when the maximum specified for such secondary component is met. Such embodiments prevent excessive duplication of identical secondary components that are contributed to the final composition.

At least one of the plurality of compositions is recorded, according to further particular embodiments, and, more specifically, a secondary producer is identified and provided with a recording including the primary component and the secondary component generated by the secondary producer so identified.

The inventive method is beneficially practiced in producing compositions of an artistic nature. Thus, according to certain particular embodiments, the composition is a musical composition, such as a song performed by a band during a concert before an audience. In such embodiments, the primary component can include, for example, at least one track selected from the group consisting of a vocal track and an instrumental track. The secondary component is then selected from the group consisting of at least one vocal track, at least one percussion track and at least one instrumental track.

According to certain additional particular embodiments, the composition is a visual artwork, such as a painting, a drawing, a film, a video, a photograph, or a computer-generated graphic work. In these embodiments, the secondary component can be selected from the group consisting of at least one color and at least one shape.

Compositions produced according to embodiments of the inventive method are not limited to a single medium, such as music or a visual artwork. Thus, in additional specific embodiments, the composition so produced includes elements produced in a plurality of media, such as audio, visual, or other media.

In addition to enabling cooperative production of compositions between a primary producer and one or more secondary producers, embodiments of the inventive method enable cooperative determination of the viewing environment of a performance. Thus, in accordance with another aspect of the present invention, there is provided a method of producing a performance for viewing by a viewer. The viewer is provided with a device enabling the viewer to view an image of a performance in combination with a secondary performance component. The method includes the steps of: generating a primary performance component, the primary performance component being generated by a primary producer; selecting a secondary performance component; and enabling the viewer to view the primary performance component in combination with the secondary performance component during the performance thereof.

In particular embodiments, the primary performance component is performed by the primary producer before a live audience comprising the viewer.

The secondary performance component, in more specific embodiments, is selected from a menu provided to the viewer by use of the telecommunication device. More particularly, the secondary performance component is selected from the group consisting of a background still image, a background moving image and an alphanumeric sequence.

The performance is recorded, according to further particular embodiments, and in more particular embodiments is recorded from a plurality of viewpoints.

Other features and advantages of the present invention will become apparent to those skilled in the art from the following detailed description. It is to be understood, however, that the detailed description and specific examples, while indicating preferred embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

The invention may be more readily understood by referring to the accompanying drawings in which

FIG. 1 is a diagram illustrating a first embodiment of a method according to the invention in which a musical composition is produced by a primary producer (a rock band) performing before an audience including a secondary producer (a viewer of the performance). The secondary producer selects a percussion track, specifically a tambourine track, as the secondary component to be combined with the primary component, namely a song performed by the band, including vocal, instrumental and percussion tracks. The composition so produced is then recorded.

FIG. 2 is a diagram illustrating a second embodiment of a method according to the invention in which a plurality of secondary producers each select secondary components for combination with the primary component. Compositions are produced including some or all of the selected secondary components.

FIG. 3 is a flowchart of a “dynamic menu” for use in particular embodiments of the inventive method, which provides for withdrawal of a secondary component from a menu when that component has been selected a specified number of times, and optionally for replacement of that component on the menu with a new component.

FIG. 4 is a diagram illustrating an alternative embodiment of a method according to the invention in which a visual artwork (a painting) is produced. The primary producer, the artist, produces a painting, while the secondary producer, an audience member, selects an element for inclusion in the background of the background of the painting. The two components are combined, and a recorded image of the composition is produced.

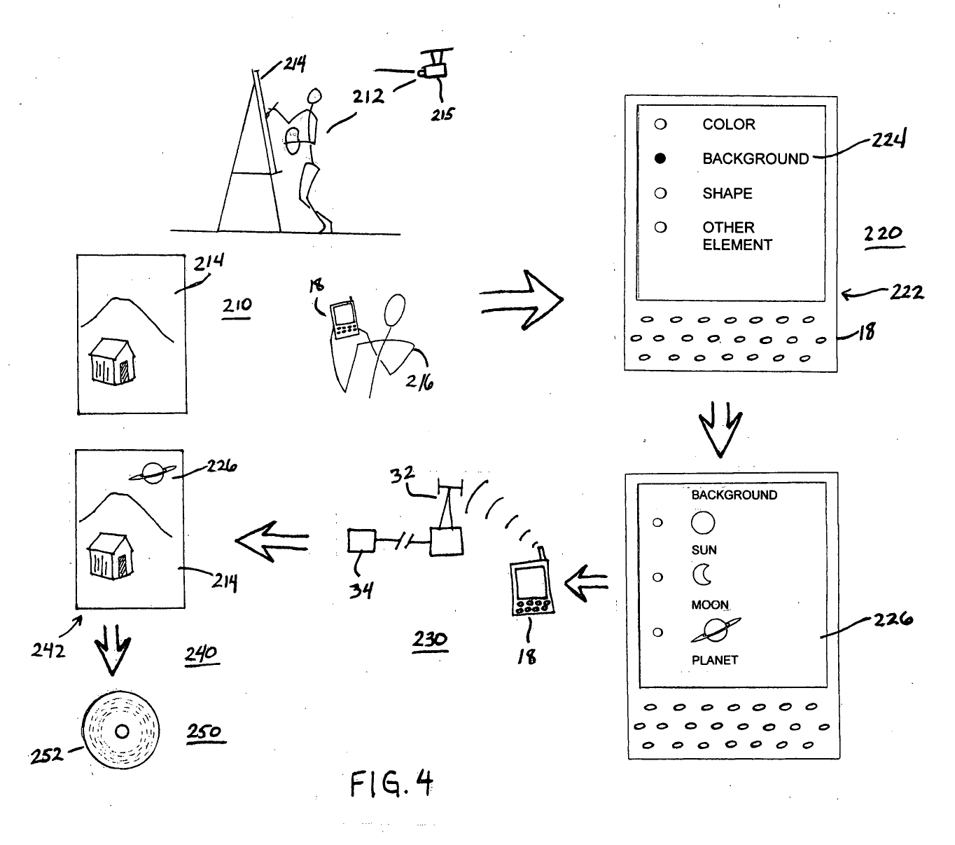

FIG. 5 is a diagram illustrating another embodiment of a method according to the invention in which a performance is viewed by members of an audience equipped with a viewing device and a telecommunication device. The viewers are enabled to view the performance unmodified and as performed, or alternatively in combination with a secondary performance component such as a computer-generated background.

Like numerals refer to like parts throughout the several views of the drawings.

### DETAILED DESCRIPTION OF THE PREFERRED EMBODIMENTS

Methods according to the invention afford audience members the opportunity to add to live performances they witness, thus creating unique compositions, such as live versions of songs, that have added value as compared to conventionally produced compositions.

As used herein, a “composition” includes any creative expression, in any medium, whether audio, visual or other, including without limitation musical works with or without accompanying lyrics, visual works such as paintings, photographs, videos, films, digital or other computer-generated images, written works such as stories, books, plays, scripts, performances such as dances, etc. A “primary producer” is any person or group of persons who initiate the production of the composition. The production so initiated generates the “primary component” of the composition. A “secondary producer” is any person who generates an element that is submitted according to the methods described herein for combination with the primary component to produce the composition. The element so generated is a “secondary component.” Compositions produced according to various embodiments of the inventive method can include one secondary component or a plurality of secondary components, and the production processes can involve one secondary producer or a plurality of secondary producers, each of whom can contribute one or more secondary components for combination with the primary component to produce a finished composition. A “menu” can be any listing of components available to a secondary producer for selection as a secondary component of the composition to be produced according to a method of the invention, whether generated by means of a computer application, printed on a hard copy that is read by a secondary producer, or produced by any other means. The components so listed can be pre-specified, or alternatively can be newly created by a secondary producer using an appropriate application such as music-writing computer software.

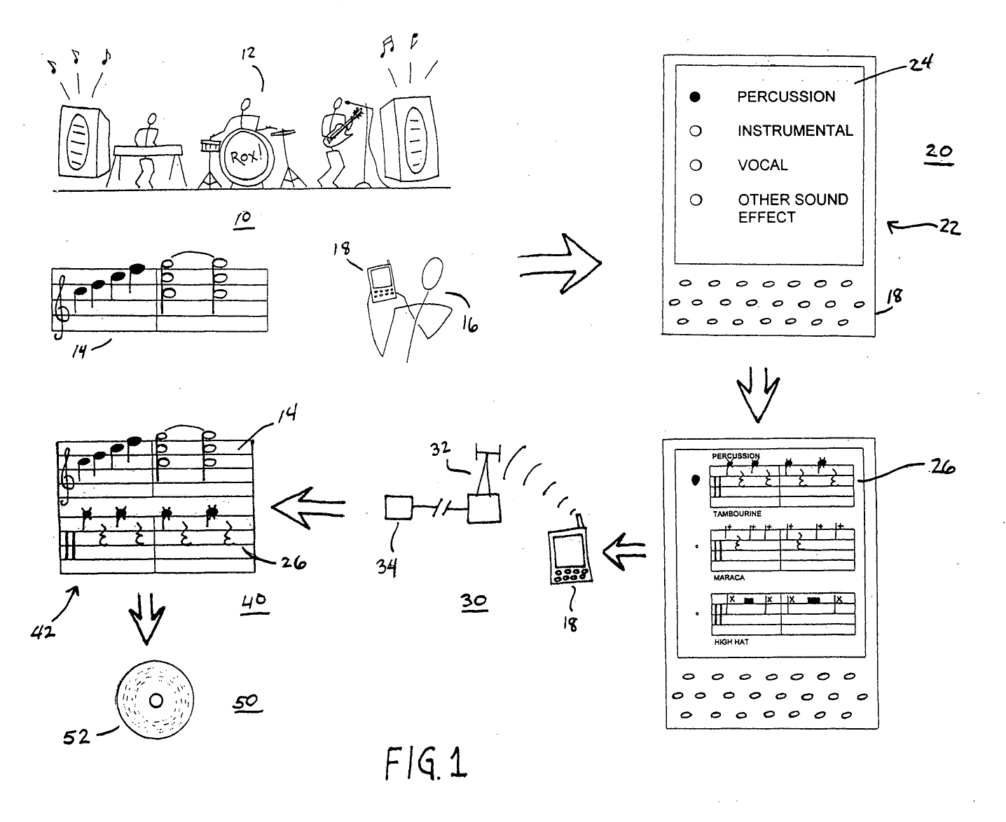

Referring now to FIG. 1, in step 10 a primary producer 12 (as shown, the rock band “Rox!”) generates the primary component 14 of a composition, which includes an instrumental track as shown, as well as additional instrumental, percussion and vocal tracks (omitted). Secondary producer 16, while viewing the performance of primary producer 12 from an audience, employs a telecommunication device 18. In step 20, secondary producer 16 accesses a first page of a menu 22 provided to telecommunication device 18, and selects a secondary component 26, first by specifying a category from a first listing of options provided on the first page of the menu (as shown, a percussion track 24), then by selecting a particular percussion track (as shown, a tambourine track).

In step 30, the selected secondary component 26 is transmitted, via telecommunication device 18 and telecommunication network 32, to central site 34 (for example, a server on a wide-area network such as the Internet, a local-area network, a computer maintained at the site of the performance by primary producer 12, etc.), to which primary component 14 is also provided via a telecommunication network, a hard line or any other desired modality.

In step 40, primary component 14 and secondary component 26 are combined, for example, using an appropriate application maintained at central site 34 or by any other desired mixing method, to produce composition 42. Composition 42 is then reproduced in step 50, for example as CD 52, which can then be provided to secondary producer 16 or others, either free of charge or upon the payment of a premium.

Composition 42 can also be provided to secondary producer 16 and/or other potential consumers prior to production or distribution of CD 52, for example via a blue-tooth transmission or other communication modality. This affords the recipient an opportunity to listen to composition 42 and decide whether or not he wishes to acquire a recorded copy of the composition.

If desired, compilations of two or more compositions 42 produced according to the foregoing method or other methods described herein can be produced and distributed in similar manner. Such compilations can also include one or more such compositions and one or more recordings of primary components without further secondary components.

Additional features such as lyric or other text files, digital autographs, video or photographic files, additional audio files or the like, can also be combined with composition 42 in various ways. For example, additional instrumental, percussion, vocal or other audio tracks can be added to composition 42 and recorded on a CD as a bonus recording, such as a “special dance mix” or other derivative work. Alternatively, a multimedia compilation can be produced including composition 42, together with one or more additional audio tracks, together with text, video or other files, and the compilation can then be recorded on a DVD or other appropriate storage medium.

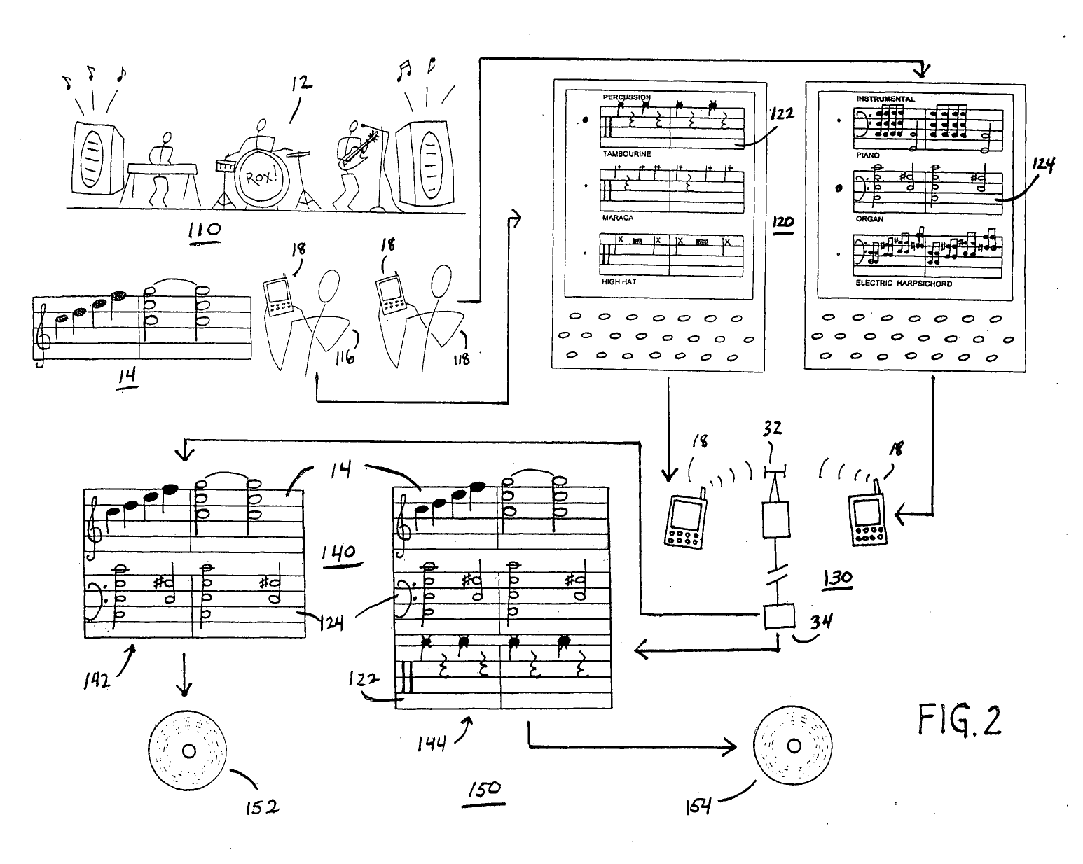

In FIG. 2, a plurality of secondary producers participate in the production of the composition. As with the previous embodiment, in step 110 primary producer 12 generates the primary component 14 of the composition. Secondary producers 116 and 118 view the performance of primary producer 12 while using telecommunication devices 18. In step 120, secondary producers 116 and 118 use telecommunication devices 18 to select secondary components 122 and 124 (as shown, tambourine and organ tracks, respectively) after specifying a category from a first listing of options as with the previous embodiment.

In step 130, the selected secondary components 122 and 124 are transmitted, via telecommunication device 18 and telecommunication network 32, to central site 34, to which primary component 14 is also provided. Next, in step 140, a plurality of compositions are produced by combining primary component 14 and one or more of secondary components 122 and 124. Thus, composition 142 is produced by combining primary component 14 with secondary component 124, while composition 144 is similarly produced by combining primary component 14 with secondary components 122 and 124. Compositions 142 and 144 can then be reproduced as with the preceding embodiment.

When a plurality of different compositions are produced, each composition can be made available to a different secondary producer. For example, if secondary producer 118 desires to obtain a copy of a composition including only primary component 14 and the secondary component he personally selected (e.g., secondary component 124), then a copy of composition 142 (e.g., CD 152) can be made available to him, free of charge or upon payment of a premium. Alternatively, if secondary producer 116 desires to obtain a copy of a composition including the primary component 14 and both secondary components 122 and 124, then a copy of composition 144 (e.g., CD 154) can be made available to him.

In order to ensure that each secondary producer is afforded an opportunity to obtain a copy of the composition of his choice, each secondary component can be associated with the secondary produce who selected it in particular embodiments. This can be accomplished, for example, by appropriate software provide to the secondary producer as part of the application used for selection of the secondary component, by providing a password or code to the secondary producer that is subsequently associated with a composition including a secondary component the secondary producer selected, or by any other desired tracking procedure.

As shown in FIGS. 1 and 2, each secondary producer selects one secondary component for combination with the primary component to produce a composition according to the invention. Secondary producers are not limited to selecting a single secondary component, however; in alternative embodiments, a secondary producer is enabled to select two or more secondary components for combination with the primary component. The secondary components so selected can be chosen from the same category (e.g., percussion tracks), or from different categories (e.g., a percussion track and an instrumental track).

Secondary components are not limited to percussion, instrumental or vocal tracks, but can include any sequence of sounds in any desired combination. Sounds effects such as explosions, mechanical or industrial sounds, samples, audio loops, or the like can also be employed as secondary components.

As illustrated, the secondary components made available to the secondary producers are pre-recorded tracks that the secondary producer need only specify for combination with the primary component. Alternatively, an appropriate application, such as Garage Band™ or the like, can be employed by a secondary producer, enabling him to actually compose an original secondary component for combination with the primary component. In such alternative embodiments, telecommunication device 18 includes or is in communication with a keyboard, touchscreen or other input device that enables the secondary producer to compose a track including one or more instrumental, percussion and/or other elements, which can be repeating or non-repeating as desired and/or as enabled by the particular application provided to the secondary producer. The application can be provided to the secondary producer via the telecommunication device 18, or can be provided by the secondary producer himself.

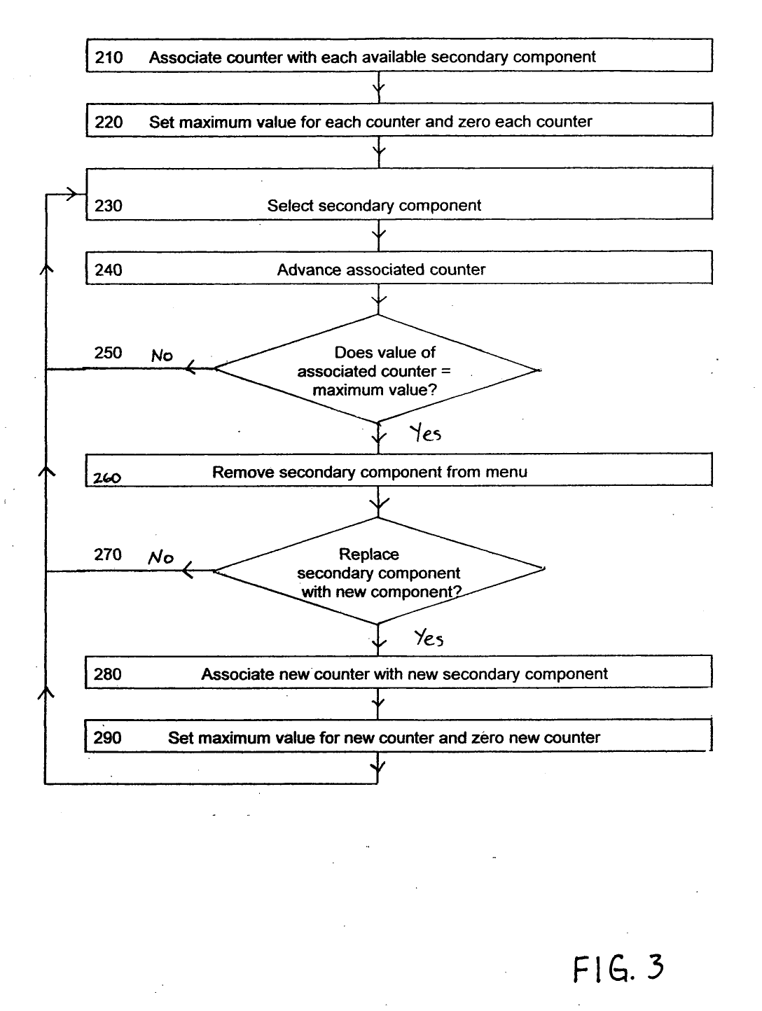

When a plurality of secondary producers participate in the production of a composition, a large number of them may select the same secondary component for combination with the primary component. It may be desirable to limit the number of times a particular secondary component can be selected, in order to prevent excessive repetition. For example, a primary producer may wish to limit the number of tambourine tracks or vocal loops that are combined with the primary component to produce a composition. Thus, in certain particular embodiments of the inventive method (“dynamic menu” embodiments), an application is provided which limits the number of times a particular secondary component can be selected, and modifies the menu provided to secondary producers when a particular secondary component is selected a specified number of times. FIG. 3 illustrates such an application. In step 210, a counter is associated with a secondary component the number of selections of which it is desired to be limited. When it is desired to limit the number of times a plurality of secondary components can be selected, each secondary component available for limitation is assigned a separate counter. A maximum value for each counter is set, and each counter is then zeroed (step 220).

When a secondary producer selects a secondary component to which a counter has been associated (step 230), the associated counter is advanced (step 240). It is then determined whether the current value of the counter equals the assigned maximum value (step 250). If the current value is less than the maximum value, then the secondary component remains on the menu. If the current value equals the maximum value, then the associated secondary component (the “maximized secondary component”) is removed from the menu (step 260).

In particular embodiments of the inventive method, subsequent choices of secondary component are made from the original menu from which the maximized secondary component has been removed. In other particular embodiments (step 270) replacement of the maximized secondary component with a new secondary component is authorized. A new counter is then associated with the new secondary component (step 280). A maximum value is specified for the new counter, and the new counter is zeroed (step 290). The revised menu is then made available to subsequent secondary producers for selection of additional secondary components.

The preceding embodiments have been directed to musical or other audio compositions. Alternative embodiments afford viewers the opportunity to participate in the creation of graphic or other visual compositions, such as paintings, drawings, films, videos, photographs, computer-generated graphic works, and the like. Turning to FIG. 3, in step 210 a painter serves as primary producer 212, and generates the primary component 214 of a composition, here a painting, an image of which is captured by camera 215 and provided to a viewing screen or other appropriate display device (not shown). Secondary producer 216 views the painter and the image of the painting from an audience. In step 220, secondary producer 16 accesses a first page of a menu 222 provided to telecommunication device 18, and selects a secondary component 226 in a manner similar to the preceding embodiments, first by specifying a category from a first listing of options provided on the first page of the menu (as shown, a background 224), then by selecting a particular background element (as shown, a planet).

In step 230, the selected secondary component 226 is transmitted, via telecommunication device 18 and telecommunication network 32, to central site 34. An image of the primary component 214 is also provided to central site 34 via a telecommunication network, a hard line or any other desired modality.

In step 240, the image of primary component 214 and the selected secondary component 226 are combined to produce composition 242, as shown a painting with a planet added to its background. Composition 242 is then reproduced in step 250, for example as a DVD 252, which can then be provided to secondary producer 216 or others as above. Additional features can also be combined with the primary and secondary components to produce a finished composition, such as the painter's autograph. Additional features such as text files, audio files, additional video or photographic files, and the like, can also be added to DVD 252 as desired by the primary producer, as requested by the secondary producer, etc., in a manner similar to the preceding embodiments.

In addition to enabling the production of recorded or otherwise reproduced images, alternative embodiments of the inventive method enable primary producer, such as the foregoing painter, to select among secondary components submitted by secondary producers, and to incorporate the selected components into the composition himself. Thus, the painter would be provided with a list of secondary components, such as background elements, selected by one or more audience member, and could then select one or more of the elements and paint the element into the painting directly, rather than waiting for images of the painting and the element to be digitally or otherwise combined.

Compositions including both audio and video elements can also be produced according to further alternative embodiments of methods according to the invention. Appropriate menus are provided to one or more secondary producers as described herein, enabling selection of one or more secondary components in the desired media for combination with primary components as described above.

In addition to enabling production of participatory compositions including primary and secondary components contributed by performers and their audiences, the invention also enables viewers of a performance to participate in the process of creating the visual environment in which a performance is perceived. Thus, instead of specifying a secondary component of a performance that is combined with a primary component to produce a finished composition that can be subsequently recorded and acquired by the secondary producer, a viewer (corresponding to the secondary producer) views a performance by a primary producer such as a musical group, but selects between viewing the performance as it is actually performed in physical space, and viewing an image of the performance combined with a secondary performance component, such as a background still or moving image, a textual element or other alphanumeric sequence, or one or more other components.

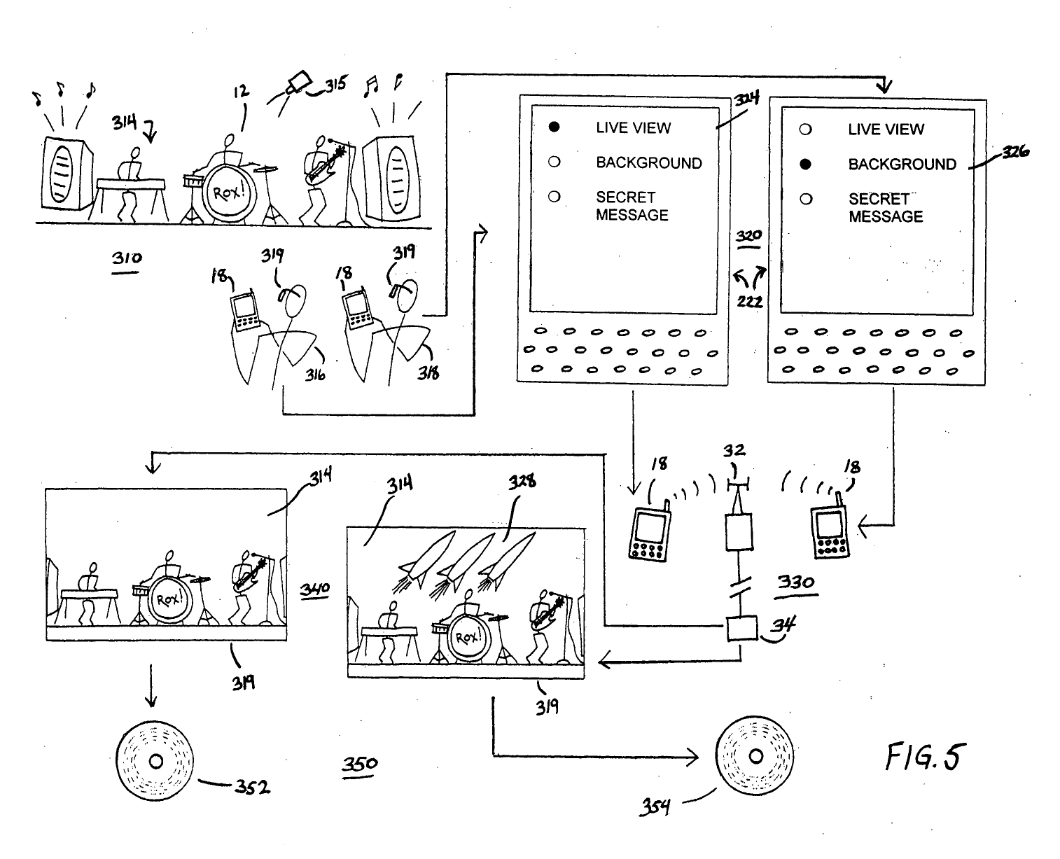

Thus, referring to FIG. 5, a plurality of viewers function in a manner analogous to the secondary producers of FIG. 2, but specify the nature of at least a portion of the performance that they will view. In step 310 primary producer 12 generates a primary performance component 314, an image of which is captured by camera 215 and provided to central site 34. Viewers 316 and 318 view the primary performance component 314 from an audience. The viewers are equipped with telecommunication devices 18, and also with visors 319, in particular visors that are in communication with telecommunication devices 18, that are adapted to receive and display projected images. Non-limiting examples of visors 319 include the MyVu™ visor device which is used in conjunction with telecommunication devices such as the I-Pod®. Other similar devices can be used if desired. In step 320, viewers 316 and 318 are provided with a menu 222 displayed via telecommunication devices 18. The viewers are afforded the option to specify the performance they will view. A viewer may select the “Live View” option 324, for example, to specify that he desires to view the primary performance component 314 as actually performed, without further embellishment. Alternatively, the viewer may select the “Background” option 326 (as illustrated), the “Secret Message!” option (e.g., a message to a specific viewer to come up to the stage, together with a password allowing stage access, or a message notifying the viewer that he has won a prize), or other options that may be provided by the primary performance producer or another party associated with the performance. Selection of such alternative options results in the generation of a secondary performance component 328. If desired, additional menu pages can be provided to afford a viewer a wider selection of background displays or other secondary performance components.

In step 330, the various viewer selections from step 320 are transmitted, via telecommunication device 18 and telecommunication network 32, to central site 34, to which the image of primary component 314 captured by camera 315 is also provided. Next, in step 340, viewers 316 and 318 are enabled to view the performance, either as performed without further modification, or in combination with a selected secondary performance component. Thus, viewer 316 views the primary performance component 314 using visor 319 (or, alternatively, with his naked eyes). Viewer 318 views the primary performance component 314 combined, by use of an appropriate computer application or other means, with the secondary performance component 326, using visor 319. Thus, as illustrated, viewer 318 views the band's performance against a background display of rockets flying through space.

The performances transmitted to visors 319 can further (step 350) be recorded, for example as DVD's 352 and 354, and made available to viewers 316, 318 and/or other potential purchasers.

Primary performance component 314, according to the foregoing embodiment, is recorded from a single viewpoint, camera 315. Alternatively, primary performance component 314 can be recorded from a plurality of different viewpoints, and by appropriate software the various viewpoints can be integrated into a single recording.

Audience members have been known to spontaneously demonstrate approval of, for example, a performance by holding aloft lit cigarette lighters. Further embodiments of the invention make use of this sentiment and enable audience members at a performance to create a visual display in conjunction with the performance of the musical composition, which can then be recorded for downloading, purchase, etc. In such embodiments, audience members, functioning as secondary producers in a manner similar to that described above, employ their telecommunication devices to receive instructions directing them to elevate their activated devices at particular times during a performance of the song, when specific lyrics are performed, or the like, optionally together with song lyrics or other texts, images, etc. associated with the performance. When the secondary producers do so, a pattern of pixels is produced, with an activated and illuminated viewing screen of each activated telecommunication device functioning as a pixel. The pattern of pixels so produced can form an image or series of images. The image(s) so produced can then be recorded as part of a recording of the performance, and the recording so produced can be accessed, downloaded, and sold as described herein.

As mentioned, song lyrics can be provided to the secondary producers in order to prompt them to elevate their telecommunication devices at specific points during the performance. Song lyrics and the like can also be provided for reading purposes only, if desired.

What is claimed is:

1. A method of producing a composition, the composition comprising a primary component and a secondary component, the method comprising the steps of:
a) generating a primary component, the primary component being generated by a primary producer,
b) generating a secondary component, the second component being generated by a secondary producer during step (a), the secondary component being selected from a menu provided to the secondary producer, and
c) combining the primary component and the secondary component to produce the composition.

2. The method of claim 1 wherein in step (a) the primary producer generates the primary component by performing before an audience comprising the secondary producer.

3. The method of claim 1 wherein the secondary producer is provided with an application that generates the secondary component, the application comprising the menu, and wherein the secondary producer selects the secondary component from the menu thereby causing the application to generate the secondary component.

4. The method of claim 3 wherein the secondary producer accesses the application using a telecommunication device.

5. The method of claim 4 wherein in step (c) the primary producer combines the primary component and the secondary component.

6. The method of claim 5 wherein the secondary producer provides the secondary component to the primary producer using a telecommunication device.

7. The method of claim 4 further comprising the step of producing a reproduction of the composition.

8. The method of claim 2 wherein in step (b) a plurality of secondary producers generate a plurality of secondary components, and wherein in step (c) a plurality of compositions are produced, each composition comprising the primary component and at least one of the plurality of secondary components.

9. The method of claim 8 wherein a counter tracks the number of times each secondary component is selected from the menu, and wherein a maximum is specified for each secondary component such that a secondary component is removed from the menu when the maximum specified for such secondary component is met.

10. The method of claim 8 further comprising the step of producing a recording of at least one of the plurality of compositions.

11. The method of claim 10 wherein a secondary producer is identified and provided with a recording comprising the primary component and the secondary component generated by the secondary producer so identified.

12. The method of claim 1 wherein the composition is a musical composition.

13. The method of claim 12 wherein the primary component comprises at least one track selected from the group consisting of a vocal track and an instrumental track.

14. The method of claim 12 wherein in step (b) the secondary component is selected from the group consisting of at least one vocal track, at least one percussion track and at least one instrumental track.

15. The method of claim 1 wherein the composition is a visual artwork.

16. The method of claim 15 wherein the visual artwork is selected from the group consisting of a painting, a drawing, a film, a video, a photograph, and a computer-generated graphic work.

17. The method of claim 16 wherein in step (b) the secondary component is selected from the group consisting of at least one color and at least one shape.

18. The method of claim 1 wherein the composition comprises elements produced in a plurality of media.

19. The method of claim 18 wherein the composition comprises audio and visual elements.

20. A method of producing a performance for viewing by a viewer, the viewer being provided with a device enabling the viewer to view an image of a performance in combination with a secondary performance component, the method comprising the steps of:
a) generating a primary performance component, the primary performance component being generated by a primary producer,
b) selecting a secondary performance component, and
c) enabling the viewer to view the primary performance component in combination with the secondary performance component during step (a).

21. The method of claim 20 wherein the primary performance component is performed by the primary producer before a live audience comprising the viewer.

22. The method of claim 20 wherein the secondary performance component is selected from a menu provided to the viewer by use of a telecommunication device.

23. The method of claim 22 wherein the secondary performance component is selected from the group consisting of a background still image, a background moving image and an alphanumeric sequence.

24. The method of claim 20 further comprising the step of producing a recording of the performance.

25. The method of claim 24 wherein the performance is recorded from a plurality of viewpoints.
